(19) United States
(12) Patent Application Publication
(10) Pub. No.: US 2026/0110213 A1
(43) Pub. Date: Apr. 23, 2026

(54) PET GATE HEIGHT ADJUSTER

(71) Applicant: Fujian Fuhele Supply Chain Co., Ltd., Fuzhou (CN)

(72) Inventor: Jin HUANG, Fuzhou (CN)

(73) Assignee: Fujian Fuhele Supply Chain Co., Ltd., Fuzhou (CN)

(21) Appl. No.: 18/921,248

(22) Filed: Oct. 21, 2024

(51) Int. Cl. E06B 9/04; A01K 1/035; E06B 9/00

(52) U.S. Cl. CPC E06B 9/04; A01K 1/035; E06B 2009/002

(57) ABSTRACT

Provided is a pet gate height adjuster capable of changing a height of a pet gate. The pet gate height adjuster includes: a board portion 31 configured to be fixed above a pet gate 1 and to increase a height of the pet gate upward; and fixing portions 32, 33 configured to fix the board portion 31 to an upper end portion of the pet gate 1. The board portion 31 includes three boards, one board is a main board 34 provided with the fixing portions 32, 33, and the other boards are two auxiliary boards 35, 36 and are to be attached to the main board 34. Attachment positions of the auxiliary boards 35, 36 to the main board 34 can be changed.

### TECHNICAL FIELD

The present invention relates to a pet gate, and more particularly to a pet gate height adjuster for adjusting a height of the pet gate.

### BACKGROUND

When a pet such as a cat is kept indoors, a pet gate that limits a movement range is used. The pet gate is vertically provided, for example, between a floor and a wall of a corridor, and partitions a space of the corridor. JP2002-201873A discloses an invention of a pet gate. The pet gate includes a frame body provided between a floor and a wall, and an opening and closing door supported by the frame body in a cantilevered manner via a hinge portion. The frame body includes a rectangular opening and rod-shaped supports. The opening and closing door is incorporated into the opening. The opening and closing door includes rod-shaped supports spaced apart from each other. On top, bottom, left, and right of the frame body, strut portions are provided that are horizontally movable forward and backward with respect to the wall. A first stop plate is provided on an upper end of the opening and closing door on a pivoting side, and a second stop plate is provided on the frame body that faces the first stop plate. Since the first stop plate and the second stop plate interfere with each other, the opening and closing door is restricted from opening outward. The opening and closing door can be opened outward by lifting the opening and closing door upward to a position where the second stop plate does not interfere with the first stop plate.

Incidentally, as for the pet gate, when a pet grows up or when starting to keep a different pet, the pet gate used up until that time may not be high enough, and the pet may climb over the pet gate and go outside.

### SUMMARY

### Technical Problem

The present invention has been made in view of the above problems in the related art, and an object thereof is to provide a pet gate height adjuster capable of changing a height of a pet gate.

### Solution to Problem

An invention according to claim 1 relates to a pet gate height adjuster including:
a board portion configured to be erected and fixed above a pet gate that includes an opening and closing door and to increase a height of the pet gate upward; and
a fixing portion configured to erect and fix the board portion to an upper end portion of the pet gate.

In an invention according to claim 2,
the board portion includes a plurality of boards,
one board is a main board provided with the fixing portion, and
the remaining one or more boards are auxiliary boards and are to be attached to the main board.

In an invention according to claim 3,
the pet gate height adjuster further includes: an attachment position-changing portion configured to freely change an attachment position of the auxiliary board relative to the main board.

In an invention according to claim 4,
the attachment position-changing portion includes
oblong slide grooves formed in the auxiliary board at a plurality of positions on upper and lower sides, and
a plurality of fastening members that are to be fitted into the slide grooves to fasten the auxiliary board to the main board.

In an invention according to claim 5,
the fixing portion includes
an attachment member that includes a lower portion provided with a fitting portion configured to be detachably fitted to an upper end portion of the opening and closing door, and an upper portion provided with a plate-shaped portion erected on the fitting portion, and
a fastening member configured to fasten the plate-shaped portion to the board portion.

In an invention according to claim 6,
the board portion is transparent.

### Advantageous Effects of Invention

According to the invention according to claim 1, when the height of the pet gate is insufficient, the height of the pet gate can be increased upward by fixing the pet gate height adjuster to the upper end portion of the pet gate.

According to the invention according to claim 2, since the board portion includes a plurality of boards, the height can be easily increased even if a width is large.

According to the invention according to claim 3, by changing the attachment position of the auxiliary board relative to the main board, the height can be increased according to the width of the pet gate.

According to the invention according to claim 4, the board portion can be changed to any width by sliding the auxiliary board relative to the main board.

According to the invention according to claim 5, by detachably fitting the fitting portion of the attachment member to the upper end portion of the pet gate, the pet gate height adjuster can be easily erected and fixed to the pet gate.

According to the invention according to claim 6, the board portion does not obstruct a field of view of a pet or an owner.

### BRIEF DESCRIPTION OF DRAWINGS

FIG. 1 is a front view illustrating a state in which a pet gate height adjuster according to an example of the present invention is used;

FIG. 2 is a front view of a pet gate in FIG. 1;

FIG. 3 is a front view of a frame body in which an opening and closing door is omitted from the pet gate in FIG. 2;

FIG. 4 is a diagram illustrating an operation of the opening and closing door in FIG. 2;

FIG. 5 is a partially omitted front view illustrating the pet gate height adjuster and an upper portion of the pet gate in FIG. 1;

FIG. 6 is a plan view of FIG. 5;

FIG. 7 is a front view of a main board;

FIG. 8 is a front view illustrating auxiliary boards;

(1) in FIG. 9 is a front view of an attachment member, and (2) in FIG. 9 is a side view of the attachment member;

FIG. 10 is a diagram illustrating a method of using the pet gate height adjuster;

FIG. 11 is a diagram illustrating the method of using the pet gate height adjuster;

FIG. 12 is a diagram illustrating the method of using the pet gate height adjuster;

FIG. 13 is a diagram illustrating the method of using the pet gate height adjuster; and

FIG. 14 is a diagram illustrating an operation of the pet gate height adjuster.

### DETAILED DESCRIPTION OF THE EMBODIMENTS

Hereinafter, a preferred embodiment of the present invention will be described using an example.

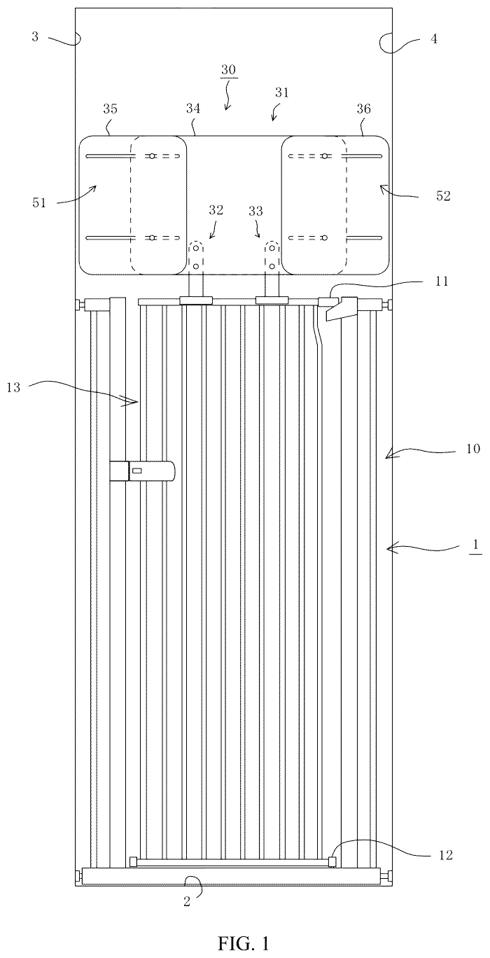

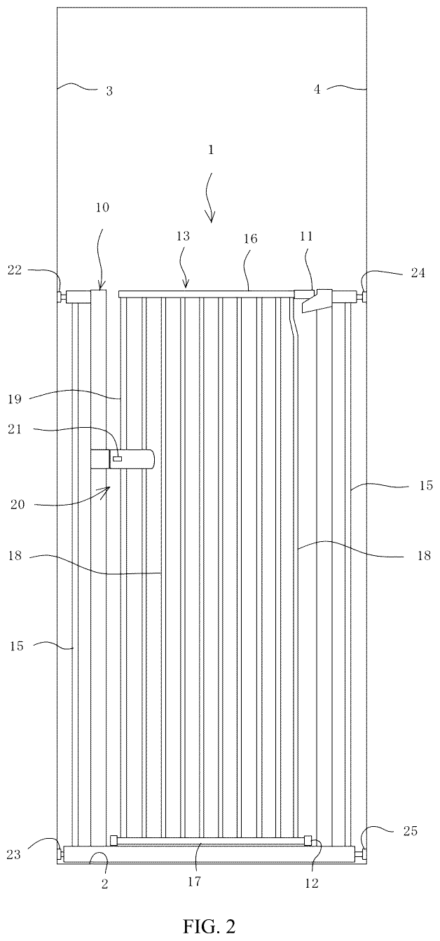

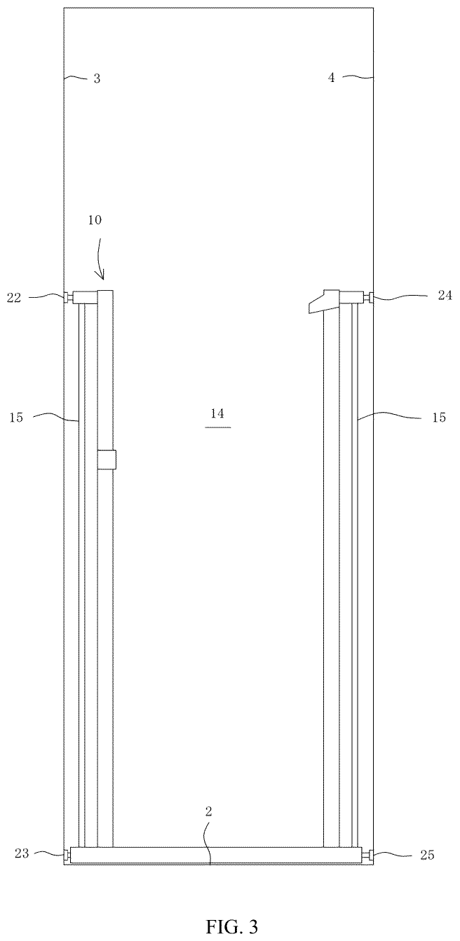

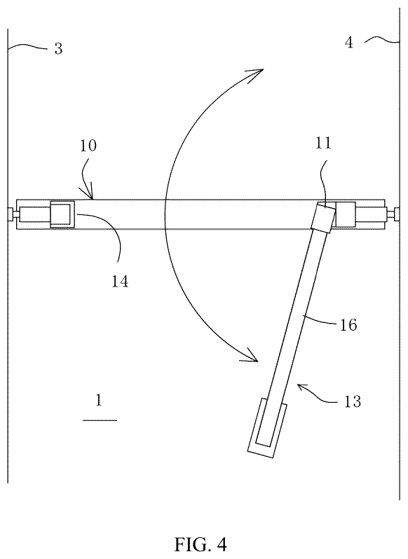

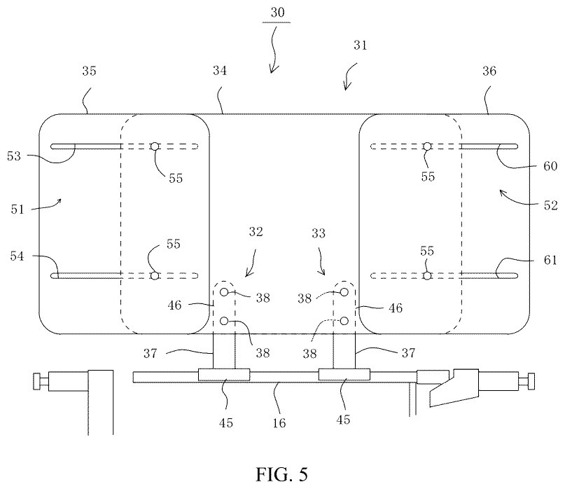

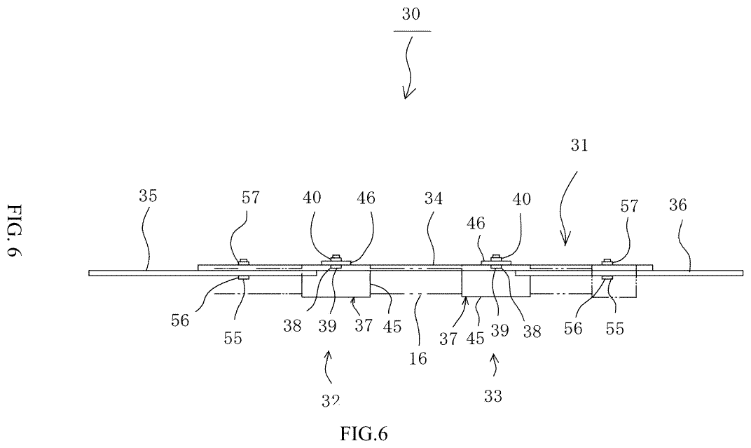

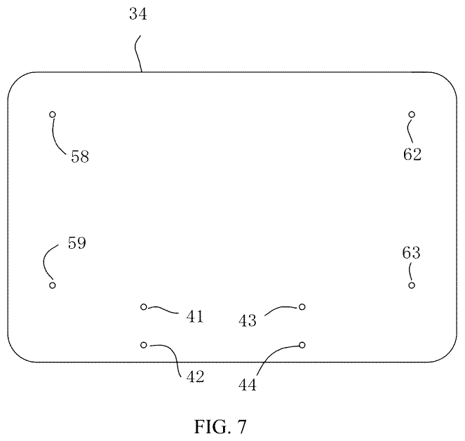

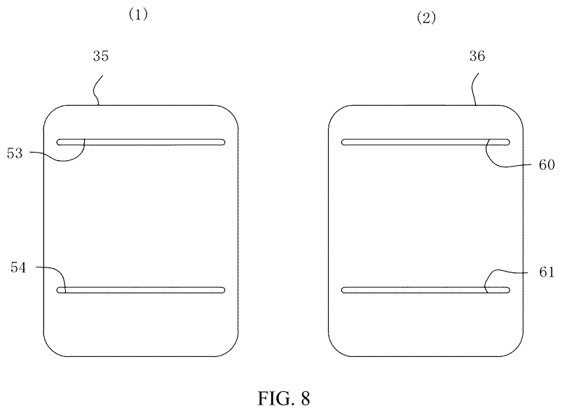

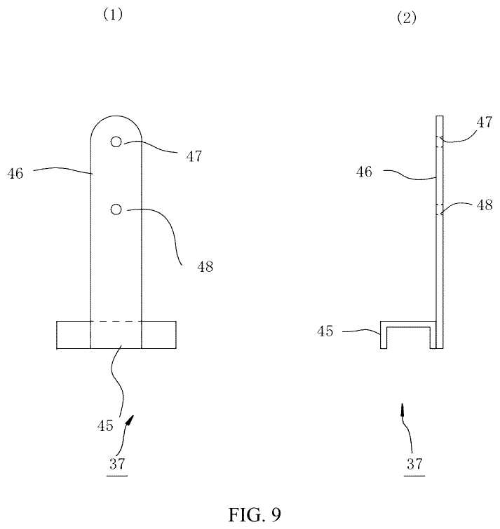

A pet gate height adjuster according to an example of the present invention will be described with reference to FIGS. 1 to 9. FIG. 1 is a front view illustrating a state in which a pet gate height adjuster according to an example of the present invention is used, FIG. 2 is a front view of a pet gate in FIG. 1, FIG. 3 is a front view of a frame body in which an opening and closing door is omitted from the pet gate in FIG. 2, FIG. 4 is a diagram illustrating an operation of the opening and closing door, FIG. 5 is a partially omitted front view illustrating the pet gate height adjuster and an upper portion of the pet gate in FIG. 1, FIG. 6 is a plan view of FIG. 5, FIG. 7 is a front view of a main board, FIG. 8 is a front view illustrating auxiliary boards, (1) in FIG. 9 is a front view of an attachment member, and (2) in FIG. 9 is a side view of the attachment member.

In these figures, reference numeral 1 denotes a pet gate, which is provided upright between a floor 2 and left and right walls 3, 4 of an indoor corridor as an example. A pet gate height adjuster 30 that increases a height upward is erected and fixed above the pet gate 1. The pet gate height adjuster 30 is used to adjust a height of the pet gate 1 in response to growth of a pet, changes in the pet, or the like. The pet gate height adjuster 30 can be added to increase the height when the height of the pet gate 1 is insufficient, or removed when an original height of the pet gate 1 is sufficient.

The pet gate 1 includes a frame body 10 provided between the floor 2 and the walls 3, 4, and an opening and closing door 13 supported by the frame body 10 in a cantilevered manner via hinge portions 11, 12. As illustrated in FIGS. 2 and 3, the frame body 10 includes a rectangular opening 14 and rod-shaped supports 15. The opening and closing door 13 is incorporated into the opening 14. The opening and closing door 13 includes an upper frame 16 and a lower frame 17 each having a prism shape at an upper end portion and a lower end portion thereof, and rod-shaped supports 18 laterally spaced apart between the upper frame 16 and the lower frame 17, and a vertical frame 19. The hinge portions 11, 12 are provided at right end portions of the upper frame 16 and the lower frame 17 of the opening and closing door 13 in FIG. 2, respectively. A lock portion 20 is provided at an intermediate position of the vertical frame 19 on a pivoting side of the opening and closing door 13 and at an intermediate position of the frame body 10 that faces the intermediate position of the vertical frame 19. The lock portion 20 can be opened and closed toward front or back by operating a release button 21 to release the lock and slightly lifting the opening and closing door 13 (see FIG. 4). On top, bottom, left, and right of the frame body 10, screw-type strut portions 22 to 25 are provided that are horizontally movable forward and backward with respect to the walls 3, 4. The strut portions 22 to 25 can be rotated to advance toward the walls 3, 4 to apply pressure, or to retract from the walls 3, 4 to release the pressure.

The pet gate height adjuster 30 includes a transparent board portion 31 that increases the height of the pet gate 1 upward, and a pair of left and right fixing portions 32, 33 that erect and fix the board portion 31 on an upper end portion of the pet gate 1 (here, the upper end portion of the opening and closing door 13 as an example). The board portion 31 includes a rectangular plate-shaped main board 34, and two identical rectangular plate-shaped auxiliary boards 35, 36 on the left and right. The main board 34 and the two auxiliary boards 35, 36 are transparent and have the same height. The fixing portions 32, 33 are attached to left and right sides of a lower portion of the main board 34, respectively. The auxiliary boards 35, 36 are attached to left and right sides of the main board 34, respectively. Attachment positions of the auxiliary boards 35, 36 in a left-right direction relative to the main board 34 can be changed, and a width of the board portion 31 can be adjusted.

The two fixing portions 32, 33 have the same configuration, and each includes a metal attachment member 37 and two fastening members 38 that fasten the attachment member 37 to the lower portion of the main board 34. Each fastening member 38 includes a bolt 39 and a nut 40. A total of four bolt holes 41 to 44 are formed on the left and right of the lower portion of the main board 34, two on top and two on bottom (see FIG. 7). The attachment member 37 includes a lower portion provided with a U-shaped fitting portion 45 that is detachably fittable to the upper frame 16 on the upper end portion of the opening and closing door 13, and an upper portion provided with a plate-shaped portion 46 that is elongated and erected upward from the fitting portion 45. The fitting portion 45 and the plate-shaped portion 46 are integrated by welding or the like. Bolt holes 47, 48 corresponding to the bolt holes 41, 42 or the bolt holes 43, 44 are formed at top and bottom of the plate-shaped portion 46 (see FIG. 9).

The main board 34 can be easily erected and fixed to the upper end portion of the opening and closing door 13 by aligning the bolt holes 47, 48 of the plate-shaped portion 46 of the attachment member 37 with the upper and lower holes 41, 42 or the upper and lower holes 43, 44 of the main board 34, performing fastening and attaching with the fastening member 38, and detachably fitting the fitting portion 45 into the upper frame 16 of the opening and closing door 13.

Reference numerals 51, 52 in FIGS. 1 and 5 denote attachment position-changing portions that change attachment positions of the auxiliary boards 35, 36 relative to the main board 34 in the left-right direction. The attachment position-changing portion 51 includes oblong slide grooves 53, 54 formed in the auxiliary board 35 at two positions on upper and lower sides, respectively, and two fastening members 55 that are fitted into the respective slide grooves 53, 54 to fasten the auxiliary board 35 to the main board 34. Each fastening member 55 includes a bolt 56 and a nut 57. Two bolt holes 58, 59 are formed at top and bottom of the left side of the main board 34. The bolt holes 58, 59 correspond to the slide grooves 53, 54. The auxiliary board 35 can be attached to the main board 34 by aligning the slide grooves 53, 54 with the bolt holes 58, 59 and performing fastening with the fastening members 55. When the fastening members 55 are loosened, the auxiliary board 35 can be horizontally slid relative to the main board 34 in the left-right direction to change the attachment position to any position.

The attachment position-changing portion 52 includes oblong slide grooves 60, 61 formed in the auxiliary board 36 at two positions on upper and lower sides, respectively, and two fastening members 55 that are fitted into the respective slide grooves 60, 61 to fasten the auxiliary board 36 to the main board 34. Each fastening member 55 includes the bolt 56 and the nut 57. Two bolt holes 62, 63 are formed at top and bottom of the right side of the main board 34. The bolt holes 62, 63 correspond to the slide grooves 60, 61. The auxiliary board 36 can be attached to the main board 34 by aligning the slide grooves 60, 61 with the bolt holes 62, 63 and performing fastening with the fastening members 55. When the fastening members 55 are loosened, the auxiliary board 36 can be horizontally slid relative to the main board 34 in the left-right direction to change the attachment position to any position.

The width of the board portion 31 can be adjusted by the attachment position-changing portions 51, 52.

A method of using the pet gate height adjuster 1 will be described with reference to FIGS. 10 to 14 and FIG. 1.

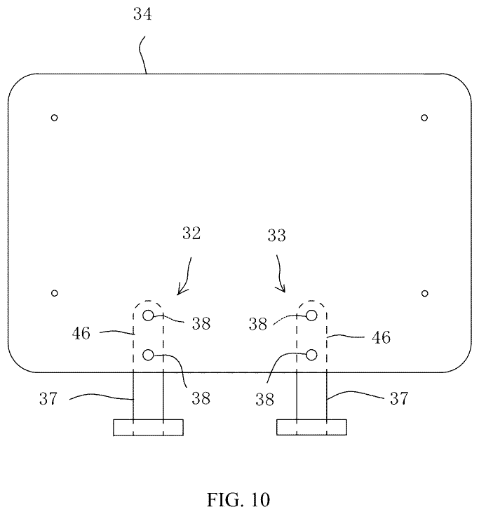

First, a method of assembling the pet gate height adjuster 1 will be described with reference to FIGS. 10 to 12.

The two attachment members 37 are attached to the left and right of the lower portion of the main board 34 using the fastening members 38. At this time, the bolt holes 47, 48 of the first attachment member 37 are aligned with the bolt holes 41, 42 of the main board 34, the bolts 56 are passed through the bolt holes, and the nuts 57 are screwed and fastened, respectively. Further, the bolt holes 47, 48 of the second attachment member 37 are aligned with the bolt holes 43, 44 of the main board 34, the bolts 56 are passed through the bolt holes, and the nuts 57 are screwed and fastened, respectively. Accordingly, the main board 34 equipped with the two fixing portions 32, 33 is assembled (see FIG. 10).

When a width of the pet gate 1 to which the pet gate height adjuster 30 is attached is narrow and a width of the main board 34 is substantially the same as the width of the pet gate 1, the board portion 31 including only one main board 34 may be used, and the fitting portion 45 of the attachment member 37 may be detachably fitted to the upper frame 16 of the opening and closing door 13 in this state, and the pet gate height adjuster 1 may be erected and fixed. The height of the pet gate 1 is increased upward by a height of the board portion 31 (here, a height of the main board 34).

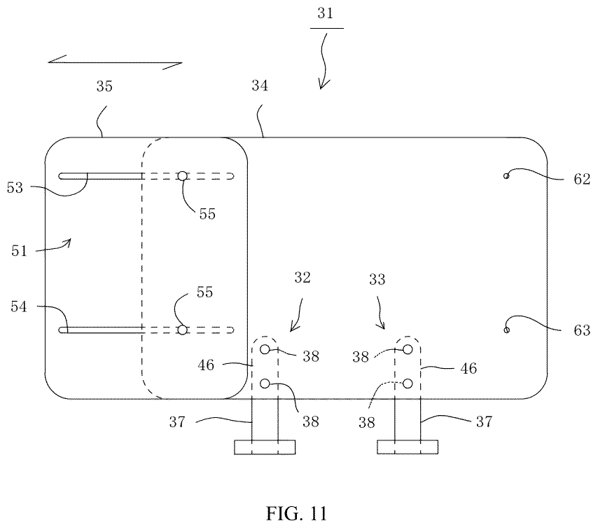

When the width of the board portion 31 is slightly insufficient with only one main board 34, for example, one auxiliary board 35 is attached to the left side of the main board 34. Specifically, the slide grooves 53, 54 of the auxiliary board 35 are aligned with the bolt holes 58, 59 on the left side of the main board 34, the bolts 56 of the fastening members 55 are passed through the bolt holes, and the nuts 57 are screwed and fastened, respectively. Accordingly, a wide board portion 31 including two boards 34, 35 can be formed (see FIG. 11). When it is desired to widen or narrow the width of the board portion 31, the attachment position can be changed as desired by loosening the fastening members 55, horizontally sliding the auxiliary board 35 relative to the main board 34 in the left-right direction, and refastening the auxiliary board 35 (see an arrow in FIG. 11).

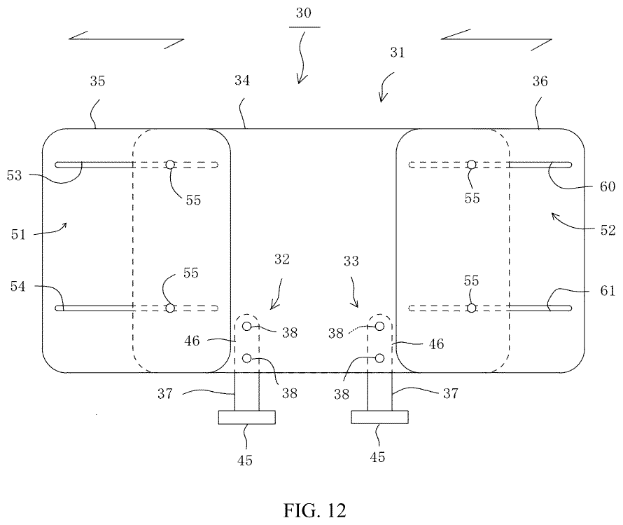

If the width of the board portion 31 is still insufficient with the two, the main board 34 and the auxiliary board 35, the slide grooves 60, 61 of the second auxiliary board 36 are aligned with the bolt holes 62, 63 on the right side of the main board 34, the bolts 56 of the fastening members 55 are passed through the bolt holes, and the nuts 57 are screwed and fastened, respectively. Accordingly, the board portion 31 including three boards can be formed (see FIG. 12). The attachment position can be changed as desired by loosening the fastening members 55 of the auxiliary board 35 or 36, horizontally sliding the auxiliary board 35 or 36 relative to the main board 34 in the left-right direction, and refastening the auxiliary board 35 or 36 (see arrows in FIG. 12).

By attaching the auxiliary boards 35, 36 to the main board 34 in this manner, a width of the pet gate height adjuster 30 can be greatly increased. The width of the pet gate height adjuster 30 can be adjusted as desired by changing the attachment positions of the auxiliary boards 35, 36 relative to the main board 34.

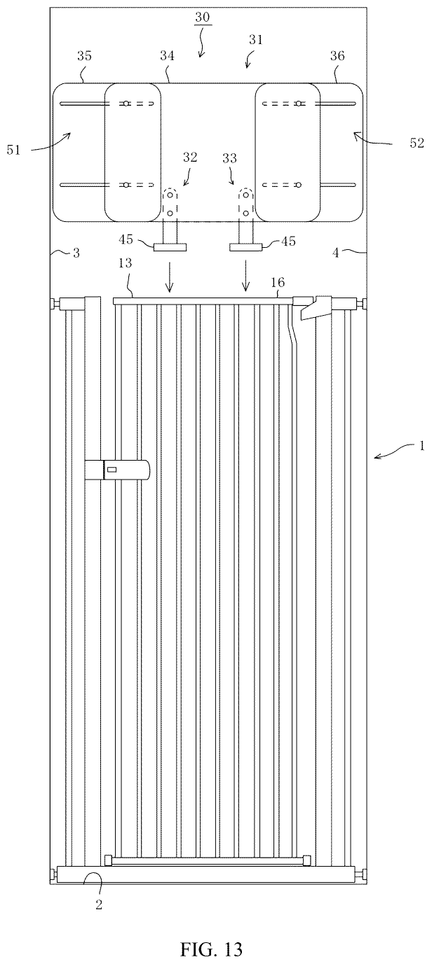

After the board portion 31 including the main board 34 and the auxiliary boards 35, 36 is assembled as described above, the fitting portion 45 of the attachment member 37 may be detachably fitted to the upper frame 16 of the opening and closing door 13, and the pet gate height adjuster 30 may be erected and fixed above the pet gate 1 (see arrows in FIG. 13). The height of the pet gate 1 is increased upward by the height of the board portion 31. Further, even if the width of the pet gate 1 is larger than the width of the main board 34, the auxiliary boards 35, 36 can reliably close gaps between left and right outer sides of the main board 34 and the walls 3, 4.

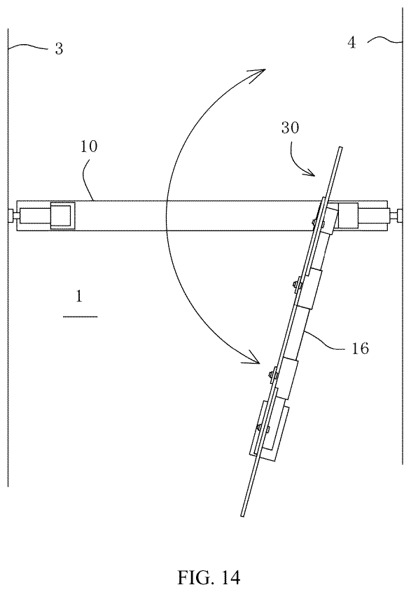

The board portion 31 is transparent, and thus does not obstruct a field of view of an owner or a pet. Further, when the opening and closing door 13 is opened or closed, the pet gate height adjuster 30 is pivoted together with the opening and closing door 13 while being erected and fixed above the opening and closing door 13, and thus does not obstruct an opening or closing operation (see FIG. 14).

According to this example, when the height of the pet gate 1 is insufficient, the height of the pet gate 1 can be easily increased upward by fixing the pet gate height adjuster 30 on the upper end portion of the pet gate 1 (in this example, the upper end portion of the opening and closing door 13).

Since the board portion 31 includes a plurality of boards, the height of the pet gate can be increased even if the width of the pet gate is large.

By changing the attachment position of the auxiliary board 35 or 36 relative to the main board 34, the height can be increased according to the width of the pet gate 1.

By sliding the auxiliary board 35 or 36 relative to the main board 34, the board portion 31 can be easily adjusted to any width.

By detachably fitting the fitting portion 45 of the attachment member 37 to the upper frame 16 of the upper end portion of the opening and closing door 13 of the pet gate 1, the pet gate height adjuster 30 can be easily erected and fixed on the upper end portion of the pet gate 1.

Since the board portion 31 is made transparent, a field of view of a pet or an owner is not obstructed.

In the above example, the board portion includes one main board and two auxiliary boards. However, the present invention is not limited to this, and the board portion may include only one main board, or one main board and one auxiliary board.

The oblong slide grooves that constitute the attachment position-changing portion are provided at two positions on the upper and lower sides of the auxiliary board, but may be provided at one position at a center in an up-down direction or three positions at upper, middle, and lower sides.

A case where the slide grooves of the attachment position-changing portion are provided in the auxiliary board has been described as an example. However, the slide grooves may be provided on the main board, and the bolt hole may be provided in the auxiliary board.

Although the fixing portion is of a fitting type, other fixing methods such as a clip type and a vice type may also be used.

The attachment position may be changed stepwise by changing the slide grooves of the attachment position-changing portion to a plurality of bolt holes arranged side by side.

### INDUSTRIAL APPLICABILITY

The present invention can be applied to a pet gate that partitions a corridor or the like in order to restrict a movement range of a pet such as a cat indoors.

### REFERENCE SIGN LIST

1 pet gate
13 opening and closing door
16 upper frame
30 pet gate height adjuster
31 board portion
32, 33 fixing portion
34 main board
35, 36 auxiliary board
37 attachment member
38, 55 fastening member
53, 54, 60, 61 slide groove

What is claimed is:

1. A pet gate height adjuster comprising: a board portion configured to be erected and fixed above a pet gate that includes an opening and closing door and to increase a height of the pet gate upward; and a fixing portion configured to erect and fix the board portion to an upper end portion of the pet gate;
wherein the fixing portion includes an attachment member that includes a lower portion provided with a fitting portion that is configured to be detachably fitted to an upper end portion of the opening and closing door, and an upper portion provided with a plate-shaped portion erected on the fitting portion, and a fastening member configured to fasten the plate-shaped portion to the board portion; and
the fixing portions are attached to left and right sides of a lower portion of the main board, respectively; the auxiliary boards are attached to left and right sides of the main board, respectively; attachment positions of the auxiliary boards in a left-right direction relative to the main board can be changed, and a width of the board portion can be adjusted.

2. The pet gate height adjuster according to claim 1, wherein the board portion includes a plurality of boards, one board is a main board provided with the fixing portion, and the remaining boards are auxiliary boards and are to be attached to the main board.

3. The pet gate height adjuster according to claim 2 further comprising: an attachment position-changing portion configured to freely change an attachment position of the auxiliary board relative to the main board.

4. The pet gate height adjuster according to claim 3, wherein the attachment position-changing portion includes oblong slide grooves formed in the auxiliary board at a plurality of positions on upper and lower sides of respective auxiliary boards, and a plurality of fastening members that are to be fitted into the slide grooves to fasten the auxiliary board to the main board.

5. (canceled)

6. The pet gate height adjuster according to claim 1, wherein the board portion is transparent.
